(19) United States
(12) Patent Application Publication
(10) Pub. No.: US 2022/0289067 A1
(43) Pub. Date: Sep. 15, 2022

(54) UNIVERSAL BATTERY PACK, ELECTRIC VEHICLE POWERTRAIN DESIGN AND BATTERY SWAPPING NETWORK WITH BATTERY HEALTH MANAGEMENT

(71) Applicant: Feyijimi Adegbohun, Pflugerville, TX (US)

(72) Inventor: Feyijimi Adegbohun, Pflugerville, TX (US)

(21) Appl. No.: 17/682,381

(22) Filed: Feb. 28, 2022

Related U.S. Application Data
(60) Provisional application No. 63/131,737, filed on Dec. 29, 2020.

(51) Int. Cl. B60L 53/80; B60K 1/04; B60L 58/26; B60L 50/60; B60L 53/64; B60L 58/10; H01M 10/613; H01M 10/6567; H01M 10/6554; H01M 10/42; H01M 50/249; H01M 10/625; H01M 10/48

(52) U.S. Cl. CPC B60L 53/80; B60K 1/04; B60L 58/26; B60L 50/60; B60L 53/64; B60L 58/10; H01M 10/613; H01M 10/6567; H01M 10/6554; H01M 10/4257; H01M 50/249; H01M 10/625; H01M 10/482; B60L 2210/10; B60K 2001/005

(57) ABSTRACT

A Universal Battery Pack (UBP), electric vehicle powertrain design and battery swapping network with battery health management enabling a user of an electric vehicle to access data such as state of health monitoring to enable advanced interface with the electricity grid to address challenges in the adoption of electric vehicles which include cost, range anxiety, charging time and infrastructure, and impacts of vehicle to grid (V2G) operations. The electric vehicle powertrain design is equipped with swapping capability, the modular swappable battery packs, battery storage apparatus, and the bidirectional charging systems. The present invention discloses a method for monitoring, assessing and controlling the battery pack and charger, and the communication interface between the systems and the electricity grid and across the battery swapping network. The present invention provides a cost-effective way of adopting electrification, reducing strain on the electricity grid during peak periods and extending the life of electric vehicle batteries.

The present application claims the benefit of U.S. Provisional Application No. 63/131,737, filed Dec. 29, 2020; all of which is incorporated herein by reference.

### FIELD OF THE INVENTION

The present invention relates to a design of battery packs and systems capable of participating in the battery sharing network, design of an interface for connecting the battery sharing network to an electricity grid, a methodology for optimizing the charge and discharge of the batteries in the network, a method for collection and sharing vital information across the network and finally a method for optimal scheduling of swaps across the network. The present invention also relates to a system for swapping, storing, monitoring and controlling batteries and electric vehicles within a battery swapping station that is part of a larger, electricity grid tied, battery sharing network.

### BACKGROUND

The transportation industry is one of the largest emitters of greenhouse gases in the world. Greenhouse gas emissions from electricity and heat production have also increased to concerning levels as populations and urbanization has increased. The sustainability and environmental concerns of the greenhouse gas emissions produced by these economic sectors have led to the development of renewable energy generation sources such as solar and wind for electricity production and the increased adoption of electric vehicles (EV) as an alternative to internal combustion engines (ICE) in the transportation sector.

The alternative forms of energy generation and transportation too have their own set of challenges. For example, renewable energy generation through solar and wind is heavily dependent on the availability of wind or solar radiation from the sun during the day. As a result, the production of energy through solar and wind is often described as a “feast or famine”. The variability of solar and wind as the sources of energy often leads to either a surplus of production and a need for curtailment or the lack of production enough to fulfil the base load. To address the variability issues, the renewable energy resources like solar and wind are often installed with local energy storage units such as batteries or pumped hydro (Pumped-storage hydroelectricity (PSH), or pumped hydroelectric energy storage (PHES)) are used. The batteries or the pumped hydro store surplus energy generated and fulfil the base load demand when generation is not up to par or is unavailable. However, installation of the batteries or pumped hydro is very expensive.

In addition, adoption of electric vehicles comes with its own challenges. The challenges include, but not limited to, cost of batteries, range of the electric vehicle from a single charge, charging infrastructure and battery life and degradation. The electric vehicles rely on a battery pack comprising a number of identical batteries or individual battery cells as the energy storage medium needed for propulsion power. The battery packs make up one to two thirds the cost of the electric vehicle and are expensive. Current energy storage for the applications described thus far rely on lithium-ion (Li-ion) based battery chemistries due to their energy density, long cycle life and power density properties. The cost of producing Li-ion batteries is relatively expensive for a variety of reasons. The reasons include, but not limited to, low availability of raw materials needed, geo-political and ethical concerns in the mining and supply chain of the raw materials, the current costs of investments for research and development, tooling and expertise, and logistics needed to produce the batteries at scale. Some of the above reasons have caused a slowdown in the adoption rate of electrified transportation despite its efficiency and simplicity benefits, as the cost of electric vehicles is significantly higher compared to its ICE counterpart.

Further, the energy density of Li-ion based batteries is less when compared to the energy density of gasoline and diesel, which have up to 40 times more energy density than that of the Li-ion based batteries. Although the electric vehicle has an efficiency rating that could be up to 10 times or more that of diesel, the limitation of weight and volume of battery packs on-board the vehicle leads to a limited amount of drivable range on-board the vehicle. The drivable range presents anxiety for drivers of EV's with longer range requirements. In addition, the required amount of time needed to fully charge a depleted battery pack varies between 1 to 12 hours depending on charge power or speed, battery chemistry, battery size, and charging methods. The charging requirements, compared to filling up a vehicle at a gas station which could take anywhere from 5 to 15 mins, further highlight the challenge of drivable range.

Global EV sales today are currently under 10 million vehicles. However, the global EV sales are expected to grow up to 125 million vehicles by 2030 due to government policies, incentives, and rising interest amongst major automakers. The future of transportation is also largely expected to become autonomous and shared, with autonomous electric (AV) cars, vans, trucks, drones and heavy duty vehicles expected to be constantly driven around, delivering people, goods and services all across the globe with minimal down time. As EV/AV volume scales, the charging infrastructure challenge of the electric vehicles can be split into two, with downstream challenge involving the availability of EV chargers in appropriate locations to meet charging demands of electric vehicles and the upstream challenge of generation, transmission and distribution infrastructure needed to meet the additional electricity demand of such high penetration of electrified transportation. The large-scale penetration of EVs will impact the reliability and safety of the electricity grid due to the randomness and uncertainty of EV users' charging behavior in the spatial and temporal domain. The decision of where and when a user is likely to charge or discharge in vehicle to grid (V2G) applications become difficult to predict. From the distribution grid operators perspective, these decisions are dictated by a number of direct and indirect factors including: battery characteristics, power supply, EV size, geographical location, quantity/scale of EVs, downstream charging infrastructure, policies, incentives and subsidies, traffic conditions, charging price, operational model, environmental impact and many more factors. This challenge of modeling charging and discharging of EVs varies significantly from traditional load modeling due to both the temporal and spatial complexity of EV charging load, as EV are mobile in nature, while the typical load profile is stationary and typically only varies in time, such as homes, office buildings, industries and so on. The advent of autonomous electric vehicles adds further complexity to the charging infrastructure challenge as these vehicles will be expected to see minimal downtime and will drive a significant number of daily miles. The possibility of EVs to also push power back into the grid from their onboard battery also add further complexity to the system model. Inaccurate forecasting of EV charging/discharging load, can lead to unforeseen load that could be detrimental to the grid, therefore some form of flexibility is needed at the charging station that can accommodate for the complexities in the prediction of EV charging/discharging load such as local energy storage or generation at, or near, the EV charging station or charging location.

Battery degradation is another challenge that electrified transportation faces. Due to the inherent nature of Li-ion battery chemistries, degradation of the battery components over time is inevitable, however this degradation can be accelerated by several different factors. Li-ion batteries have a very finite operating temperature range which when exceeded, could cause temporary or permanent damage to the cells, and could cause accelerated degradation when operated at the extremes of the temperature range. Li-ion batteries also have a strict power density curve which dictates the charge/discharge rate and hence the charging power and charging speed. Direct Current Fast Charging (DCFC) for example, is a means of increasing the charging speed of Li-ion batteries and reducing charging wait times; however, studies have shown that the repeated use of DCFC to charge Li-ion can lead to accelerated degradation of the cells. The configuration of Li-ion cells to form a battery pack, parallel or series connections or a combination of both, the specific cathode and anode materials that form the cells, the shape and enclosure of the cells (cylindrical, prismatic, pouch cells), operational duty cycle, calendar aging, and even the method of cooling or heating the cells (air, liquid, thermoelectric, heat pumps, resistive heating) could all contribute to the degradation of a cell. Li-ion cell degradation could sometimes be a safety concern as cells could sometimes experience a phenomenon known as thermal runaway which could be destructive or sometimes explosive if cells are operated or stored at elevated temperatures for too long or cells are improperly vented. The high costs of batteries highlighted earlier as well as the safety concerns, make battery degradation an imminent issue needing to be addressed. Thermal runaway and other battery degradation mechanisms could however be avoided or mitigated through advanced cell monitoring, control of charging and discharge and accurate estimation of cell of states and parameters.

Several attempts have been made in the past to address some of the challenges discussed above. One such example is disclosed in a United States granted U.S. Pat. No. 10,894,484, entitled “Electric automobile energy monitoring and swapping network in remote monitoring of cloud computing network” (“the '484 patent”). The '484 patent discloses a remote energy monitoring and swapping network for electric vehicle based on cloud computing network, which uses cloud computing technology, Internet of Things technology, video identification technology and remote monitoring system with remote monitoring center based on multi-type monitoring system to control electric vehicle, remote battery monitoring system and battery swapping system. The remote monitoring center and battery swapping system replace the first battery pack and the second battery pack on the electric vehicle chassis in nine steps. Battery swapping station solves the problem of battery energy supply by station nets, which lays a theoretical and technical foundation for the popularization of electric vehicles. The remote monitoring center's control of the whole battery swapping process improves the work efficiency, saves labor cost and reduce battery cost.

Another example is disclosed in a United States granted U.S. Pat. No. 10,300,801, entitled “Battery swapping system and techniques” (“the '801 patent”). The '801 patent discloses a system for exchanging an electrical energy storage system (EESS) of an electric vehicle. The EESS station is configured to position an electric vehicle in x and y directions. A vehicle lift raises the electric vehicle to a predetermined height. An EESS lift supports and lowers the EESS and replaces the EESS with a differing EESS. The vehicle lift may be an inboard lift and the EESS lift may be an outboard lift. The system may also include one or more rollers configured to guide the electric vehicle. The system may include a horizontal door having at least one tube positioned thereon for guiding the electric vehicle and/or at least one vehicle chock for positioning the electric vehicle in at least one of the x and y directions. The vehicle lift may include lifting arms to engage jack pads of the electric vehicle.

Although the above disclosures are useful, still there is a need in the art to provide innovative designs of a battery pack, vehicle platform that allows for reconfigurable vehicle components based on the application, and battery swapping and vehicle to grid systems with battery health and performance monitoring and estimation such that the battery swapping is made time is short, the power exchange efficiency is high, and the user experience is improved.

### SUMMARY OF THE INVENTION

Considering the above problems that exist in the shift towards renewable energy generation and the adoption of electrification with issues related to energy storage cost, charging load modeling, charging infrastructure and battery management, the present invention provides a number of innovations, designs and inventions that are aimed at providing a wholistic solution to the problems that have been highlighted thus far. These innovations range from a broader system of battery sharing and charging networks, to battery swapping stations, to monitoring and optimization methods for managing the systems disclosed, to innovative designs of the battery pack and vehicle platform that allow for reconfigurable vehicle components based on application.

According to one aspect of the present invention, a modular electric vehicle battery pack is disclosed which consists of a high voltage connection, an intelligent wireless on-board battery management system, geographic position sensor, an onboard cooling system, a DC/DC converter, and an on-board wide band gap bidirectional AC/DC charger. The modular battery pack is optimized for battery swapping in electric vehicle applications as well as Vehicle to Grid (V2G) stationary applications and supporting electricity grid. The physical enclosure design of the battery pack is designed with the intent to mate with battery collection frame latches through a battery box kingpin.

Another variation of the modular battery pack is also disclosed. The modular battery pack consists of a closed loop cooling system. This battery pack variation may have no external inlet/outlet for cooling the battery pack, instead all the components for cooling are embedded within the battery pack itself. The closed loop cooling system in one specific design consists of an electric fan, an electric pump, a chiller plate, a radiator, a heater coil, an electric AC compressor, and hoses all within the battery pack itself. The electric components in the battery pack are powered through the DC/DC converter that is onboard the battery pack, eliminating the need for an external power source. In another design, the cooling system features an air cooled heat sink that is pressed onto one or more sides of the battery pack separated by a heat exchange material such as aluminum which also forms a part of the structure of the battery pack. This novel design allows for ease of battery sharing and enables use in stationary applications as the battery pack can easily be connected to the vehicle platform with fewer connections with no need for complicated liquid coolant connections. This design also allows for the battery pack to function as an independent power source when used in stationary applications or charged off-board the vehicle at a battery swapping station.

An intelligent wireless battery management system (BMS) that is capable of monitoring cells within a battery pack, active balancing individual cells across the battery pack, protecting the battery pack from various fail mode conditions such as overcurrent protection, over/under voltage conditions, over/under temperature conditions, measurement and estimation of states and parameters such as state of charge, state of power, state of health, internal resistance, usable capacity, operating temperature, estimated duty cycle, and an Internet of Things (IoT) communication device for reporting this information wirelessly to the vehicle on board controller, battery swapping station or cloud connected charge management system is designed and implemented. The system is capable of actively balancing the cells onboard the vehicle during charging or shortly after through a balancing circuit that measures the voltage across each individual cell and slowly bleeds off overcharged cells into cells that are undercharged or into a bleeding resistor as heat. The BMS also includes an onboard computer/controller and a wireless communication module used for estimation and control of the BMS functions, and for sharing of information from the BMS to the various external systems such as battery swapping stations, electricity grid and/or a battery sharing network (BSN). The algorithms for estimating some of the non-trivial estimations such as state of health (SOH) are also presented in the present disclosure.

In another aspect of the present invention, a swappable electric vehicle platform is disclosed. The swappable platform allows for a variety of vehicle body platforms to be combined with the same electric vehicle platform. The swappable electric vehicle platform features the electric powertrain, battery collection frame and modular battery pack. The swappable electric vehicle platform, in automotive applications, also incorporates a steering rack motor that can be controlled wirelessly through a steering wheel sensor, a wireless embedded controller for controlling the electric motor and braking system through wireless signals from the throttle and brake pedal on board the interchangeable vehicle body. Further, the swappable electric vehicle platform allows for wireless selection of drive modes and gears from a wireless gear selector aboard an interchangeable vehicle body.

In another aspect of the present invention, a novel electric vehicle mechanical powertrain is disclosed. The electric vehicle mechanical powertrain consists of a single electric motor with a four-wheel drive (4WD), two speed transmission-transfer case and stock front and rear differentials with a rear axle drive shaft to drive the rear wheels and a front axle drive shaft that powers the front wheels. The electric motor is mounted to the vehicle with a tripod configuration, given the two mounts behind the electric motor and a third mount in front of the motor where the motor adapter housing mates with the transfer case. The mounts are supported with rubber bushings to allow for absorbing torque vibrations of the motor during operation. The configuration allows for a single motor to provide power to either the rear axle, the front axle or both axles on the electric vehicle through the transfer case and front and rear differentials. The configuration also allows for selection of two different gears through a gear selector on the transfer case for a high and low gear. The motor and transfer case are linked mechanically through a custom shaft with an internal spline on the motor side (female end) and an external spline on the transfer case side (male end).

A battery collection frame which is a structural member of the vehicle platform and consists of a fifth wheel latch assembly that can be adjusted on a rack assembly to accept a modular battery pack of different sizes, dimensions and configurations. The battery collection frame may be welded or bolted to an existing subframe or form a part of the vehicle platform itself. The latch assembly contains multiple components that form the assembly similar to a standard fifth wheel latch assembly used in on-road heavy duty trucks. Two or more fifth wheels” latches are placed on the battery collection frame and adjusted through the racks to align a battery pack with a matching kingpin aligned to the latch slots and the electrical and optional coolant connections on-board the vehicle platform. The kingpin/fifth wheel latch assembly, forces compliance between the battery pack and the electrical/coolant connections on-board the vehicle platform. The fifth wheel is adjusted through the rack assembly to accommodate different battery pack dimensions and sizes. The latches can be released either manually by a user or automatically through a hydraulic or electrical actuator during swapping.

In yet another aspect of the present invention, a mobile electric vehicle battery swapping/charging station is disclosed. The battery swapping/charging station consists of a battery/vehicle platform storage rack, rails/rollers for moving battery packs with the battery storage unit, a cooling system for storing battery packs at optimal temperature, a mechanism for removal and addition of battery packs, a monitoring apparatus for communicating with battery packs, battery chargers and the battery sharing network management system. The mobile electric vehicle battery swapping/charging station is also capable of harnessing the energy from the on-board battery packs to provide charge to electric vehicles or vehicle to grid applications.

In yet another aspect of the present invention, a battery sharing network consisting of battery swapping stations that share information amongst each other, a cloud connected management system and the distribution grid, is disclosed. An advantage of the battery sharing network is its ability to provide a means by which electric vehicles can share the valuable resource, the battery, amongst each other, through the optimization of different duty cycles of vehicles within the network, thereby reducing the overall cost of the electric vehicles as the utilization of the resources can be maximized. Another advantage is that the batteries can be charged off-board the vehicle at much slower rates, when electricity is cheaper, and swapped into a vehicle quickly, reducing the need for Direct-current fast charger (DCFC) and avoiding its degradation effects on the battery while simultaneously adding resilience to the electricity grid by providing energy storage and load balancing benefits to the grid during load peaks and troughs. The battery swapping network is designed in such a way that the charging load is much more predictable, as the battery packs are scheduled ahead of time, and it can take advantage of the “feast or famine” nature of renewable energy generation with an aggregation of battery swapping stations providing temporary energy storage buffers to store energy when there is surplus and returning some of that energy back into the grid when demand exceeds generation. The battery swapping stations within the battery sharing network are connected together through internet of things (IoT) and communicate to optimize the charging costs of the battery packs, maximize utilization of the battery packs, and reduce wait times for battery swapping or vehicle platform swapping through scheduling and forecasting of swap demand and optimal routing of mobile battery swapping stations.

The cloud connected battery sharing network management platform sometimes referred to in this invention as the charge management system (CMS) is responsible for monitoring batteries, swappable electric vehicle platforms, swapping/charging infrastructure and the fleet of EV/AV across the network. CMS presents several modules including the scheduling/routing module, charging/discharging module, billing and payments modules, control module, data acquisition and monitoring modules, data analytics modules and data storage module. CMS receives inputs such as vehicle/battery health, battery state of charge, battery location and size, vehicle telematics data, electricity load and price forecasts, charging/discharging status, equipment alerts and many more. From the real-time inputs and analytical models deduced from the analytics modules, the management systems can make decisions on battery/vehicle platform swap scheduling and routing, battery charging/discharging, mobile battery swapping station assignment and routing and many more optimization and control functions.

CMS is configured to be accessible via user devices of users/EV customers'/fleet customers. The users use a mobile/web application for reserving battery packs, chargers or EV swappable platforms. The mobile application interfaces with the CMS to schedule swaps, remit payments, and share geographical location and other telemetry data. An in-vehicle application for monitoring battery pack parameters, sharing telematics information with the CMS to determine nearest charging and swapping locations, route vehicles to the swapping location and wirelessly handle payments is also disclosed.

Furthermore, the present invention discloses a data based deep neural network model for determination of battery state of health using a single charge discharge curve in real time applications, which is based on the measured observation of constant current to constant voltage transition of current measurements during charging. The algorithm is implemented on the on-board BMS of the battery pack or in the cloud connected CMS. The deep neural network model is continuously tuned for better accuracy, precision and speed and updated in the on-board BMS as needed.

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present invention will now be described in detail with reference to the drawings, which are provided as illustrative examples of the invention as to enable those skilled in the art to practice the invention. It will be noted that throughout the appended drawings, like features are identified by like reference numerals. Notably, the FIGUREs and examples are not meant to limit the scope of the present invention to a single embodiment, but other embodiments are possible by way of interchange of some or all of the described or illustrated elements and, further, wherein:

FIGS. 1A, 1B, 1C and 1D illustrate a side perspective view, a front view, a rear view and a side view, respectively of a battery latch assembly, in accordance with one embodiment of the present invention;

FIG. 2 shows interior of the battery latch assembly;

FIG. 3 shows a representative diagram of a close loop cooled battery pack, in accordance with one embodiment of the present invention;

FIG. 4 shows a representation of a modular connected battery pack, in accordance with one embodiment of the present invention;

FIGS. 5A and 5B show a perspective view and a top view, respectively of the internal construction of the battery pack, in accordance with one embodiment of the present invention;

FIG. 6 shows a representation of an on-board wireless battery management system (BMS), in accordance with one embodiment of the present invention;

FIG. 7 shows a topology of a bidirectional charger implemented on-board the battery pack, in accordance with one embodiment of the present invention;

FIGS. 8 and 9 show graphs of the current over time of a Li-ion battery cell;

FIG. 10 shows a plot of the gradient of the transition curve over the life cycle of several LiFePo cells;

FIG. 11 presents a graph showing a model's correlation, in accordance with one exemplary embodiment of the present invention;

FIGS. 12 and 13 show different battery collection boxes containing multiple battery packs that come in different configuration, in accordance with one embodiment of the present invention;

FIG. 14 shows a conceptual design of a vehicle with a new vehicle architecture, in accordance with one embodiment of the present invention;

FIGS. 15 and 16 show a perspective view and a top view, respectively of a frame assembly, in accordance with one embodiment of the present invention;

FIGS. 17, 18 and 19 show components connection in a motor assembly, in accordance with one embodiment of the present invention;

FIGS. 20, 21, 22, 23, 24 and 25 perspective views of motor mount weldment, motor adapter, electric motor, transfer case adapter, transfer case and drive shaft, respectively, in accordance with one embodiment of the present invention;

FIG. 26 shows a perspective view of battery collection frame, in accordance with one embodiment of the present invention;

FIGS. 27A, 27B, 27C and 27D show a top view, a side view and a side perspective view, and a rear view, respectively of a battery collection frame embedded in a vehicle frame, in accordance with one embodiment of the present invention;

FIGS. 28A and 28B show an isometric view and a front view, respectively of a battery collection frame latch assembly;

FIG. 29 shows a cross-sectional view of a battery collection frame latch assembly;

FIG. 30 shows a cross-sectional view of a frame latch assembly;

FIG. 31 shows individually modular swappable portions of the vehicle platform;

FIG. 32 shows a mobile battery storage unit storing a plurality of battery packs;

FIG. 33 shows a lifting member;

FIG. 34 shows a battery swapping station for swapping a battery pack, in accordance with one embodiment of the present invention;

FIG. 35 shows an electrical architecture of a battery swapping station equipped with local energy generation and a bidirectional charger that is tied to an electricity grid, in accordance with one embodiment of the present invention;

FIG. 36 shows a network diagram of a battery swapping network (BSN), in accordance with further embodiment of the architecture shown in FIG. 35; and

FIG. 37 shows an architectural diagram of a cloud connected charge management system (CMS), in accordance with further embodiment of the battery swapping network shown using FIG. 36.

It will be noted that throughout the appended drawings, like features are identified by like reference numerals.

### DETAILED DESCRIPTION OF THE INVENTION

One or more embodiments of the invention are described below. It should be noted that these and any other embodiments are exemplary and are intended to be illustrative of the invention rather than limiting. While the invention is widely applicable to different types of systems, it is impossible to include all the possible embodiments and contexts of the invention in this disclosure. Upon reading this disclosure, many alternative embodiments of the present invention will be apparent to persons of ordinary skill in the art.

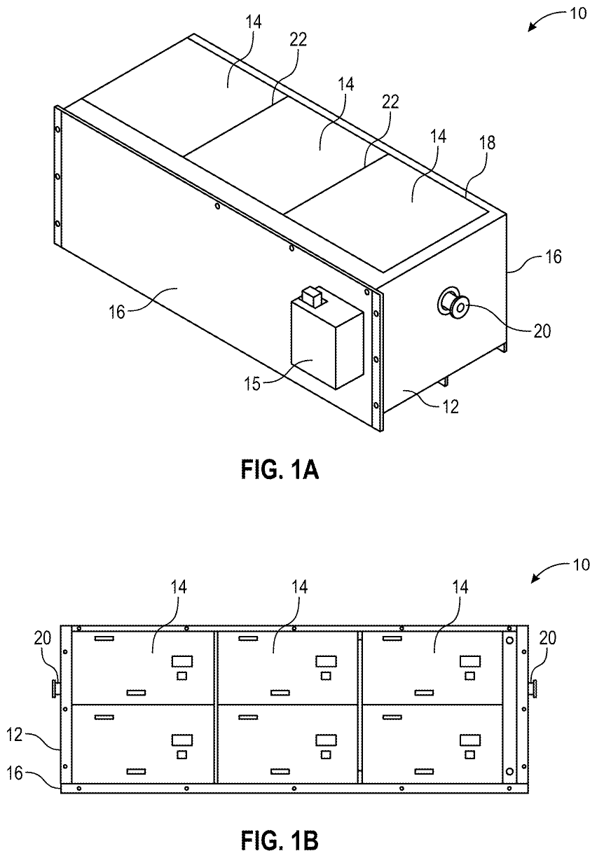

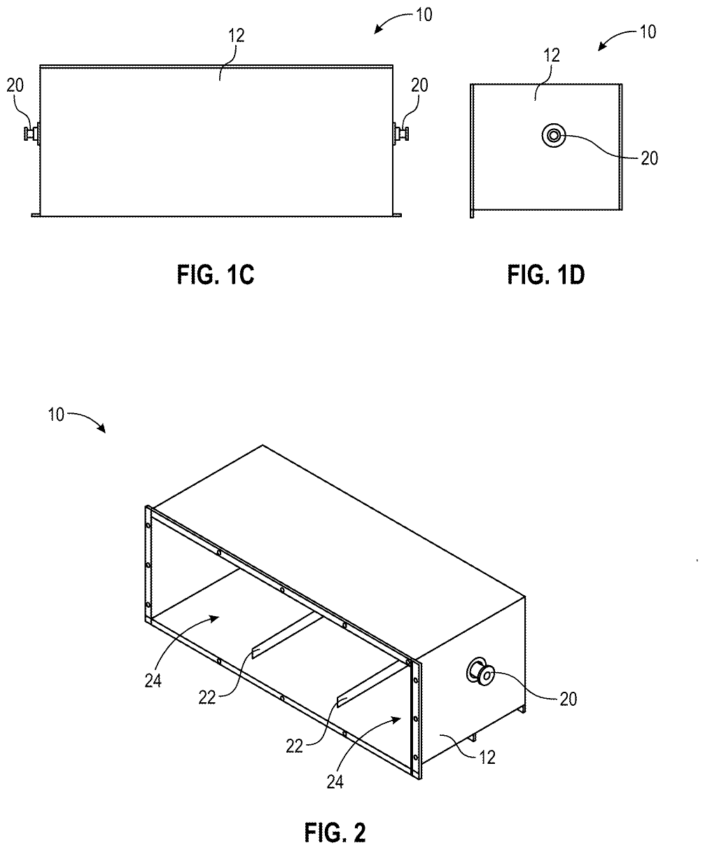

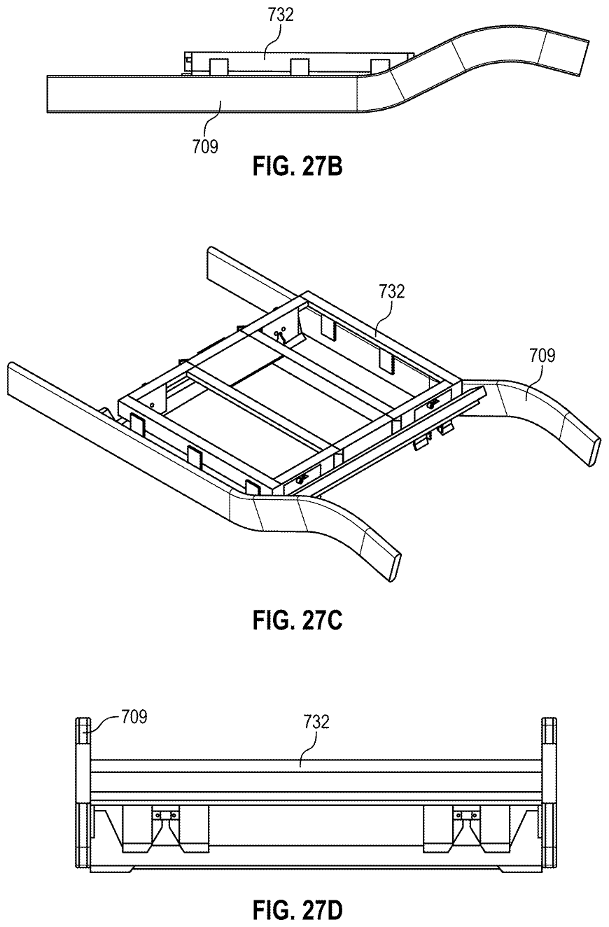

FIGS. 1A, 1B, 1C and 1D show a side perspective view, a front view, a rear view and a side view, respectively of a battery latch assembly 10, in accordance with one embodiment of the present invention. Battery latch assembly 10 presents housing 12. Housing 12 provides a material made of metal, plastic, or any other suitable material. Housing 12 comes in different shapes and sizes depending on the need. Housing 12 receives one or more Universal Battery Packs (UBP), battery packs or battery modules 14. In the present invention, the terms “Universal Battery Pack (UBP)” or “battery pack” or “battery modules” are used interchangeably. Each of battery packs 14 includes one or more lithium-ion (Li-ion) battery cells. Housing 12 encompasses High Voltage (HV) electrical connector 15 at the front, for example. Further, housing 12 encompasses cooling plate 16. In addition, housing 12 includes heat sink 18 that is pressed or adhered to cooling plate 16. Further, housing 12 encompasses kingpins 20 at its sides. Kingpins 20 help to lock battery latch assembly 10 into a battery collection frame (not shown, frame 732 in FIG. 27, for example).

In the present embodiment, the cooling system features an air cooled heat sink 18 that is pressed onto one or more sides of battery pack 14 separated by a heat exchange material such as aluminum which also forms a part of the structure of battery pack 14. This novel design allows for ease of battery sharing and enables use in stationary applications as battery pack 14 can easily be connected to a vehicle platform with fewer connections with no need for complicated liquid coolant connections. This design also allows for battery pack 14 to function as an independent power source when used in stationary applications or charged off-board the vehicle at a battery swapping station.

FIG. 2 shows interior of battery latch assembly 10, in accordance with one embodiment of the present invention. Here, housing 12 presents ridges 22 for separating battery packs 14 within battery latch assembly 10. Here, each battery pack 14 enters battery latch assembly 10 through openings 24 formed in housing 12 separated by ridges 22.

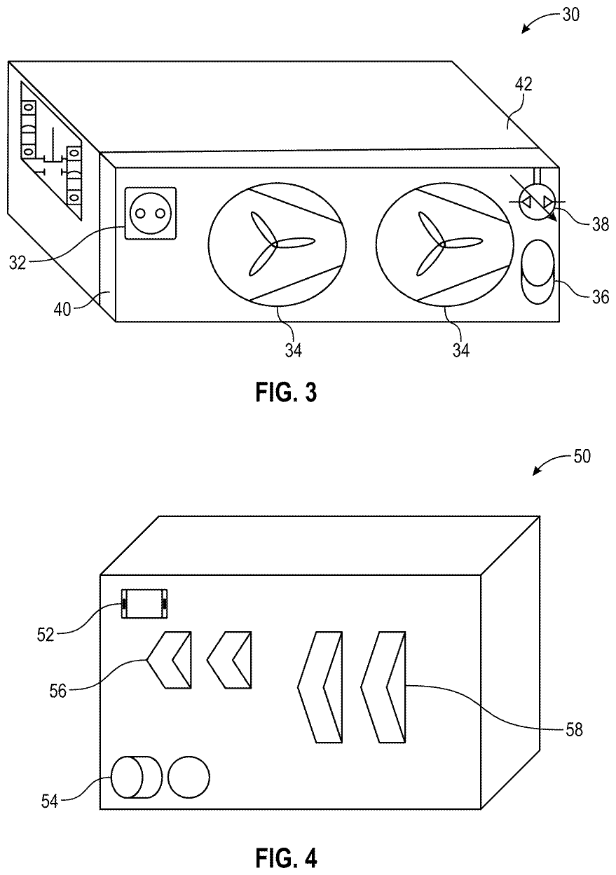

FIG. 3 shows a representative diagram of a close loop cooled battery pack 30, in accordance with one embodiment of the present invention. As known, Li-ion batteries ideally operate between 25° C. and 40° C. for optimal life and performance. Using air as a heat transfer medium is a cheap and simple method for battery cooling. However, it is very inefficient in comparison to liquid cooling. Some of the limiting factors of air cooling in EVs are limited flow rate of cooling air, noise, inhomogeneous temperature distribution within batteries, flow rate of cooling air, and dependence on vehicle cabin air temperature. Due to the strict temperature operational range of Li-ion battery packs, Li-ion batteries in Electric Vehicle (EV) applications are typically liquid cooled, however these systems are costlier and complex to implement. The thermal management responsible for cooling of an EV battery pack typically consists of a refrigerant system, a radiator, heater, pump, coolant reservoir, cold plates, coolant hoses and valves, temperature sensors and a controller. The temperature sensors, control system, and cooling plates are typically embedded within the battery pack itself while the heating/cooling unit which consists of the refrigerant system, radiator and heater are typically outside of the battery pack and on-board the vehicle due to packaging complexity and the need for other systems within the vehicle to share some of the components such as cabin heating and cooling, motor and power electronics heating and cooling.

In battery swapping and Vehicle-to-Grid (V2G) applications however, it is desirable for all of the cooling components needed to keep the battery pack within its optimal temperature to be on-board the battery pack itself. This reduces the complexity of dealing with coolant connections and spillage, and improves the standardization and flexibility of the battery packs. Therefore, a novel battery pack design is proposed in the present invention which integrates a coolant pump, radiator, fans, coolant hose and valves with controller and cold plates all within the battery pack as illustrated in FIG. 3.

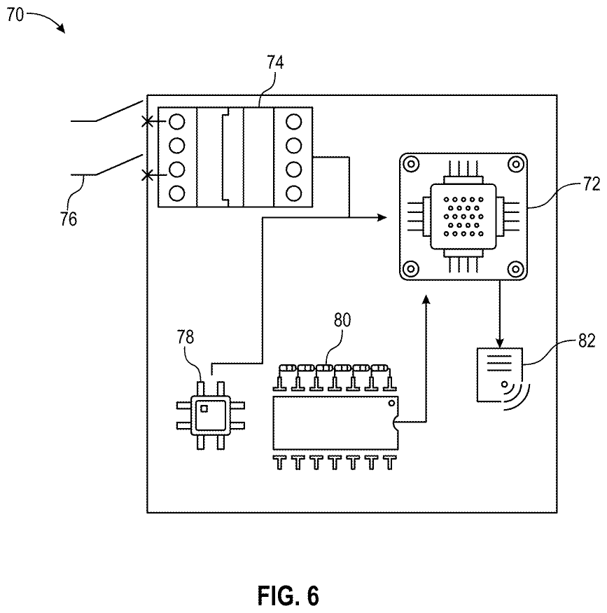

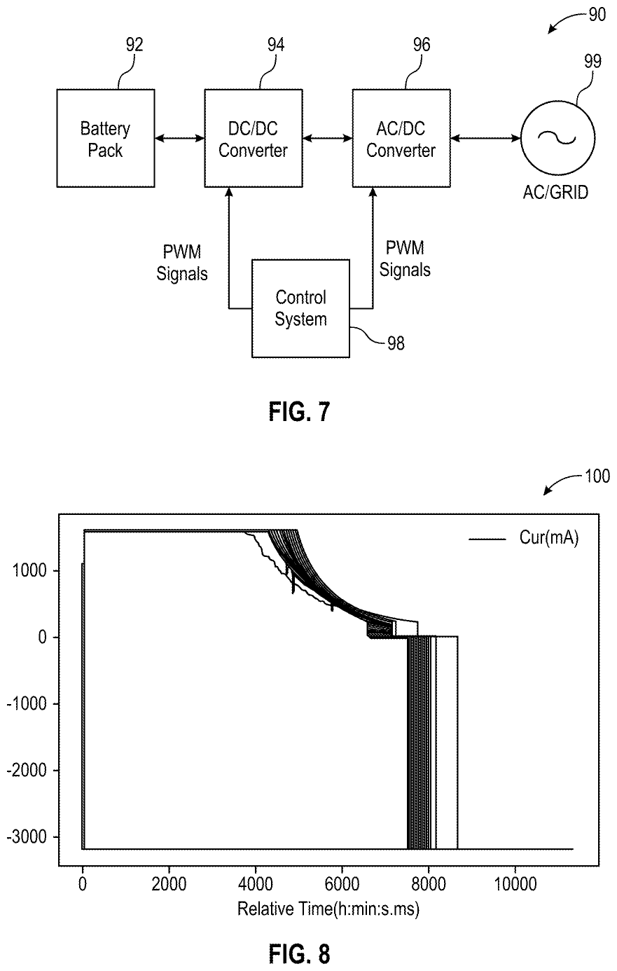

In accordance with the present invention, close loop cooled battery pack 30 includes a high voltage DC connection 32, a cooling fan 34, a compressor/chiller 36, a coolant pump 38, a radiator and condenser 40, and a coolant plate heat exchanger 42 and an onboard Battery Management System (BMS) and DC/DC converter for powering the electrical components within the battery pack 30, as described in detail in FIG. 6 and FIG. 7. Here, the electric components in battery pack 30 are powered through the DC/DC converter that is onboard battery pack 30, eliminating the need for an external power source.

In one implementation, battery pack 30 is capable of functioning without a compressor and Heating, ventilation, and Air Conditioning (HVAC) system in certain environments and with certain chemistries that have a wider range of temperature operations where a refrigerant system is not needed. For heating the battery in extreme cold weather or during a cold start, a thermoelectric heater or heat pump may be used inside the battery cooling unit. These batteries can be relied on in areas with modest weather and temperature or with chemistries such as Lithium Iron Phosphate (LiFePo) or Lithium Titanate Oxide which have a wider temperature operating range.

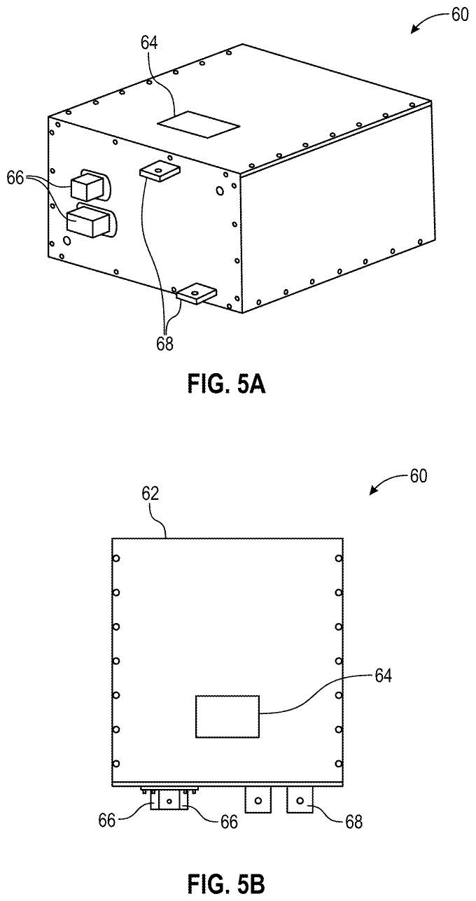

FIG. 4 shows a representation of a modular connected battery pack 50 i.e., a Universal Battery Pack (UBP) as explained above. Here, battery pack 50 consists of the battery cells configured into one or more modules. The battery cells are connected in series, parallel or a combination of both. At the outer side, battery pack 50 consists of wireless connected battery management system (BMS) 52, optional coolant ports 54, low voltage connections 54, and High Voltage (HV) connection 56. FIGS. 5A and 5B show a perspective view and a top view, respectively of the internal construction of battery pack 60, in accordance with one embodiment of the present invention. As can be seen, battery pack 60 consists of cooling plate 62 (i.e., coolant port) for an individual battery module (not shown) inside of battery pack 60. Battery pack 60 includes onboard battery management system (BMS) 64, temperature and voltage sensing connections 66 and main module connectors 68.

FIG. 6 is a representation of an on-board wireless battery management system (BMS) 70 (similar to BMS 52 in FIG. 4 and BMS 64 in FIGS. 5A and 5B). BMS 70 includes BMS controller or BMS computer 72. BMS controller 72 operates on a low power and communicates/controls other components of BMS 70. BMS controller 72 connects to battery protection circuit 74, which in turn connects to battery pack terminals 76. Further, BMS 70 includes temperature sensing module 76 configured for sensing temperature of the battery pack, say battery pack 60 in FIG. 5B, for example. BMS 70 includes BMS cell balancing and sensing module 80 configured to sense voltages of individual battery cells within the battery pack or module within an accuracy tolerance of 5 mV+/− and balancing the voltage across all of the battery cells in the battery pack. Here, BMS cell balancing and sensing module 80 balances the voltage across all of the battery cells immediately after charging or during charging of the battery cells. BMS 70 is responsible for over-charge over-discharge protection with a delay time of 1000 ms and a voltage tolerance of +/−0.1V the threshold voltage, over-discharge current protection with a delay time of 5 ms, short circuit protection with a delay time of 5 ms, temperature sensing and temperature protection with a tolerance of +/−5° C.

In accordance with one embodiment of the present invention, BMS 70 includes a wireless communication module 82 and a location sensor such as a Global Positioning System (GPS) sensor (not shown). In one embodiment, wireless communication module 82 integrates location sensing capabilities. BMS controller 72 executes different algorithms or program instructions to help the battery pack understand it's current duty cycle, state of charge, state of power, state of health and optimal operational point. Further, BMS controller 72 communicates information such as individual cell voltages, pack temperature, and battery states and parameters described to external devices such battery swapping stations and/or user devices and/or electric vehicle (EV) in which the battery pack is installed.

BMS 70 is capable of monitoring cells within a battery pack, active balancing individual cells across the battery pack, protecting the battery pack from various fail mode conditions such as overcurrent protection, over/under voltage conditions, over/under temperature conditions, measurement and estimation of states and parameters such as state of charge, state of power, state of health, internal resistance, usable capacity, operating temperature, estimated duty cycle, and an Internet of Things (IoT) communication device for reporting this information wirelessly to the vehicle on board controller, battery swapping station or cloud connected charge management system. BMS 70 actively balances the cells onboard the vehicle during charging or shortly after through BMS cell balancing and sensing module 80 that measures the voltage across each individual cell and slowly bleeds off overcharged cells into cells that are undercharged or into a bleeding resistor as heat.

FIG. 7 shows a topology of bidirectional charger 90 implemented on-board battery pack 92. Bidirectional charger 90 bidirectional charger consists of a bidirectional DC/DC converter 94, isolating transformer between the DC converter and AC converter, a full-bridge AC/DC converter 96 which consists of power semiconductor switching devices such as wide band gap switching devices made of SiC or GaN material, an EMI filter composed of an inductor and capacitor. Further, bidirectional charger 90 includes control system 98 responsible for measurements of battery voltage, current, bus voltage, power grid voltage and current, and gate drivers for PWM switching of the power electronics components. DC/DC converter 94 is controlled through a duty cycle phase shift while the AC/DC converter 96 is controlled through pulse width modulation (PWM) switching. The use of wide band gap components allows for high power density and efficiency, reducing the physical footprint of the charger within the battery pack or battery swapping station and allowing for reduced weight and cooling requirements of the charger.

In addition, bidirectional charger 90 within the battery pack 92 helps in Vehicle to Grid (V2G) applications of electric vehicles both on-board and off-board the vehicle i.e., when connected to electricity grid 99. Bidirectional charger 90 onboard the battery pack 92 assists in providing V2G when the vehicle is plugged in at a Level 1 or 2 charger, when battery pack 92 is used in standalone stationary applications, or when the battery is used out in the field at mobile battery swapping stations that are not equipped with chargers or in remote locations for battery to battery (B2B) or vehicle to vehicle charging (V2X). These range of bidirectional applications call for modular battery charger 90 that is embedded within battery pack 92 itself.

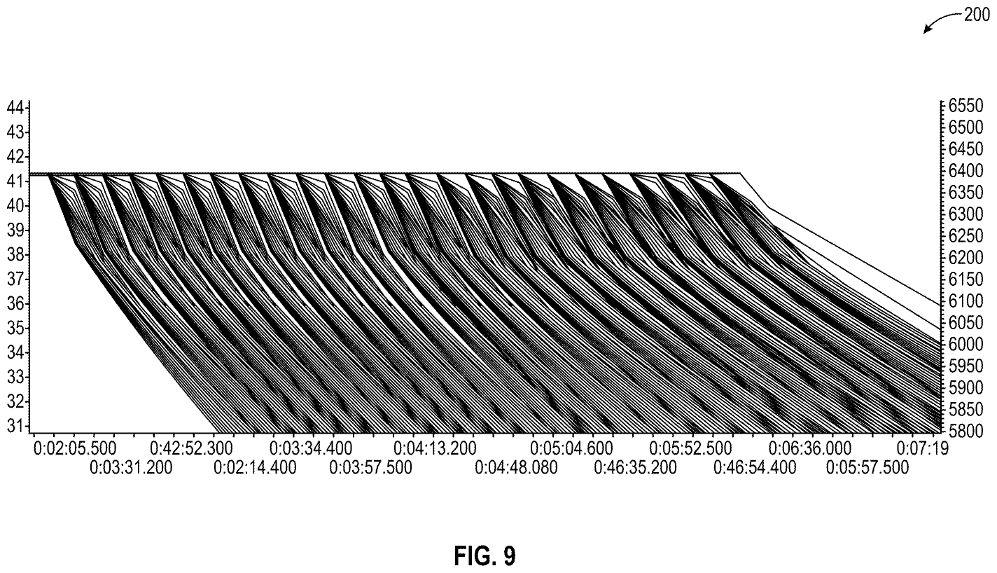

The presently disclosed battery pack containing Li-ion battery cells reduces the degradation of the battery cells as they age. FIGS. 8 and 9 show graph 100 and graph 200, respectively of the current over time of a Li-ion battery cell that has been cycled for multiple cycles in order to study the aging and degradation mechanisms of the battery cell, in accordance with one exemplary embodiment of the present invention. From the graph 100 and graph 200, it can be observed that the current curve as the battery cell ages changes specifically near the constant current and constant voltage transition during charging. The slope of the curve starts to become steeper as the cell ages and the curves can be used to quickly deduce the point in the life cycle of the cell, a parameter which is critical to the safety and longevity of Li-ion cells. Based on the information available, the battery cells and battery packs either individually or within a network of battery packs can be assessed and either adjusted for more suitable duty cycles or redeployed for alternative applications such as stationary energy storage applications depending on the need.

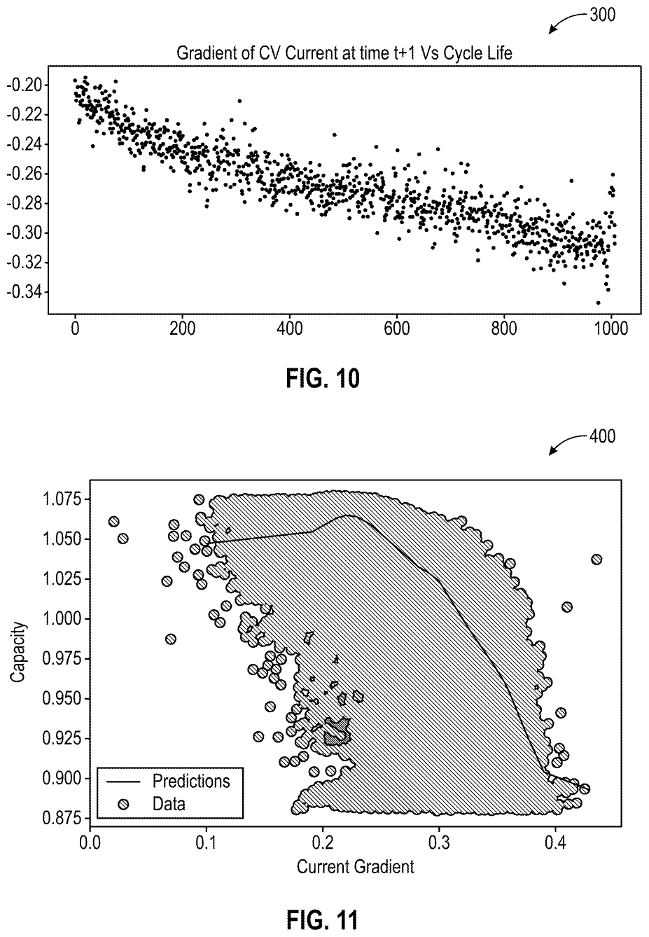

Further, FIG. 10 shows a plot 300 of the gradient of the transition curve over the life cycle of several LiFePo cells that have been cycled. From the plot 300, the trend can be observed that the negative slope continues to become steeper over the life cycle of the battery cells. In order to validate the above assumption or theory, several LiFePo cells of 1100 mAh were cycled in a laboratory environment and data was collected from the battery cells. The data is used to train a deep neural network in order to obtain a model for determining battery state of health from a single charge/discharge curve. The input of the model is the gradient of the CC-CV charge curve transition and the output of the model is the capacity of the cell at the time of charge, representing the cell SOH. FIG. 11 presents a graph 400 showing the model's correlation i.e., a validation of the model's prediction on real data.

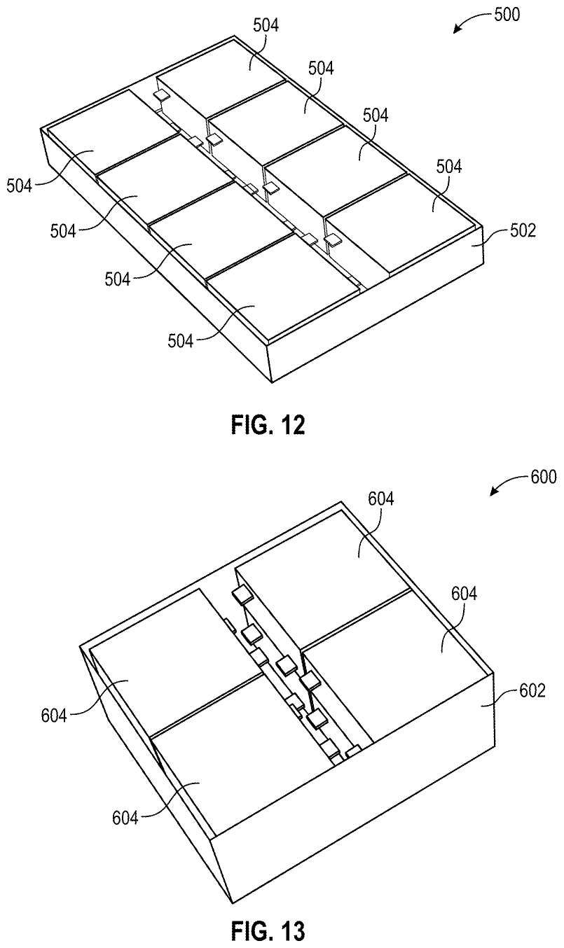

The battery pack can come in different configurations, dimensions and sizes depending on the need. For example, a battery pack for powering an electric car can come in different shapes and sizes when compared to another battery pack for powering an electric truck. Here, the battery packs enclose in a battery collection box for easy transportation or swapping depending on the need. FIGS. 12 and 13 illustrate different battery collection boxes 500 and 600 containing multiple battery packs that come in different configurations depending on the need. For instance, battery collection box 500 comes in a rectangular configuration. Here, battery collection box 500 encompasses housing 502 having a mechanism (not shown) for receiving battery packs 504 of various configuration and size via their respective kingpins, as explained above. Similarly, battery collection box 600 comes in a square configuration. Here, battery collection box 600 encompasses housing 602 having a mechanism (not shown) for receiving battery packs 604 of various configuration and size via their respective kingpins, as explained above. Based on the above, a person skilled in the art understands that battery collection box latches can be adjusted using a latch rack assembly (not shown) to accommodate varying battery pack configuration and size in real time.

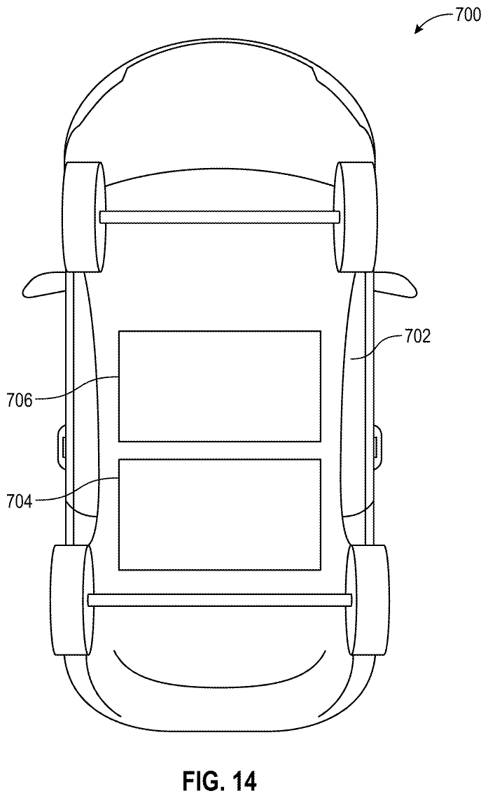

In accordance with further embodiment of the present invention, new vehicles or existing vehicles can be customized to mount the battery pack, as explained above. FIG. 14 shows a conceptual design of a vehicle 700 with a new vehicle architecture. Here, vehicle 700 includes frame assembly 702 that features a primary or custom battery pack 706 which can be combined with UBP 704 of the present invention. UBP 704 is designed to work in combination with the custom battery pack 706 on-board the vehicle 700 already. Frame assembly 702 is designed such that frame assembly 702 acts as a vehicle swappable platform and presents an easy way to swap the UBPs 704.

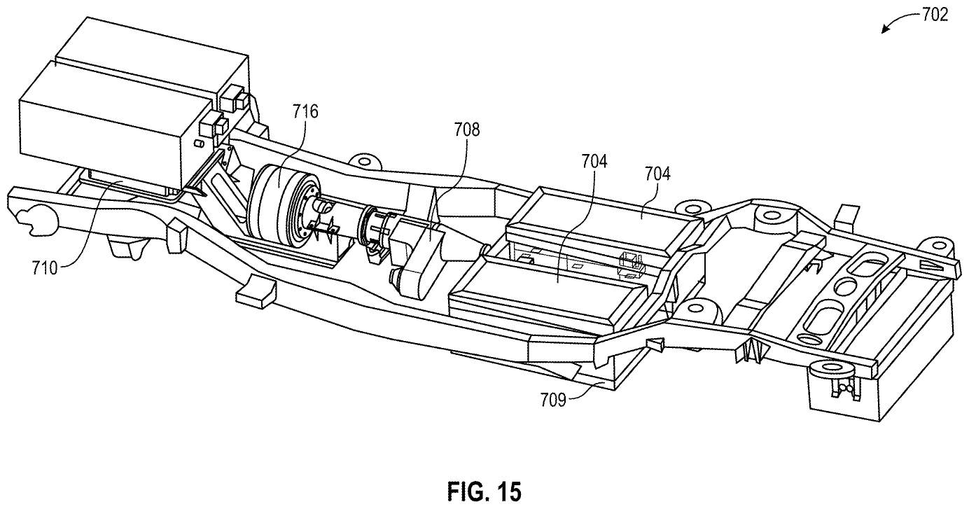

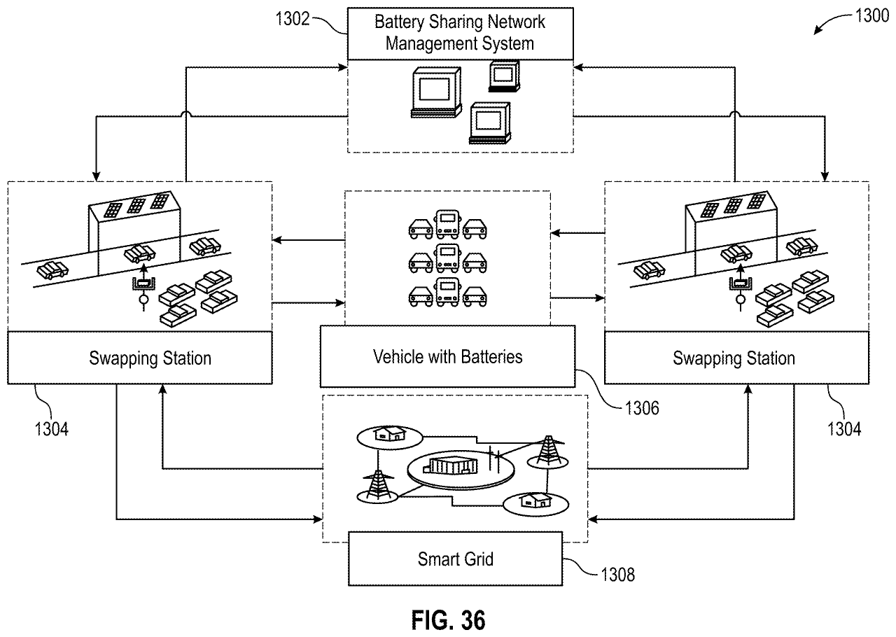

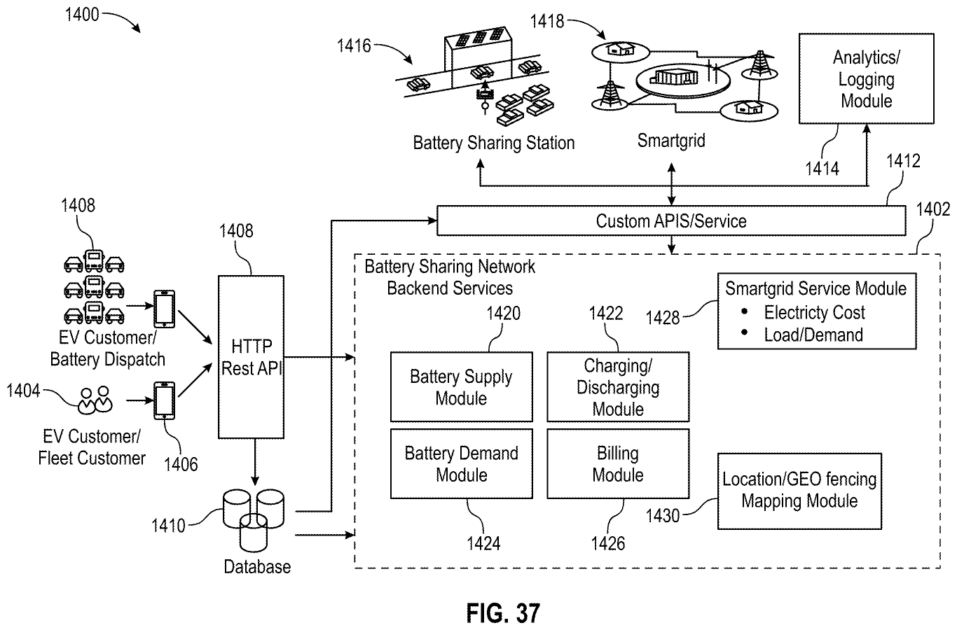

UBP 704 in combination with custom battery pack 706 provides additional range when required. As can be seen from the exemplary design in FIG. 14, custom battery pack 706 can be provided either at the front or rear of vehicle 700. Custom battery pack 706 can be permanently affixed to vehicle 700, enough to cover the daily driving needs of vehicle 700. This greatly reduces the load demand that vehicle 700 puts on the grid as the battery can be charged over a long stretch of time at night when load is minimal, and the electricity is cheaper. UBP 704 is configured to sit in a custom designed battery collection box 709 (FIG. 15) having slots (not shown) in vehicle 700 to provide the EV flexibility to participate in a battery sharing network (explained in the later part of the description using FIGS. 36 and 37). The frame assembly 702 can be standardized or customized to fit any vehicle built with a traditional frame such as class 1-8 trucks and capable of providing a range of 50-200 miles or more depending on vehicle weight, duty cycle and vehicle dynamics. The battery packs i.e., UBP 704 can be scheduled or made available on demand at the battery swapping network.

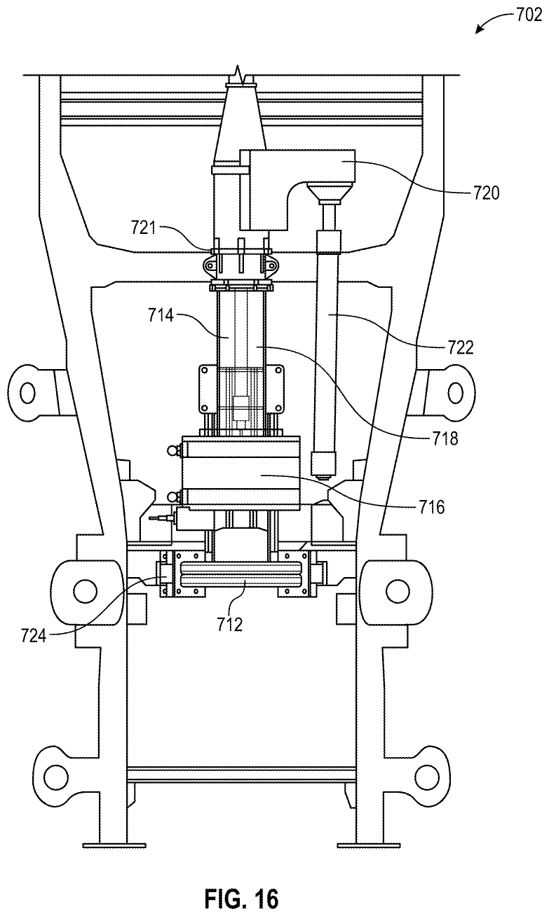

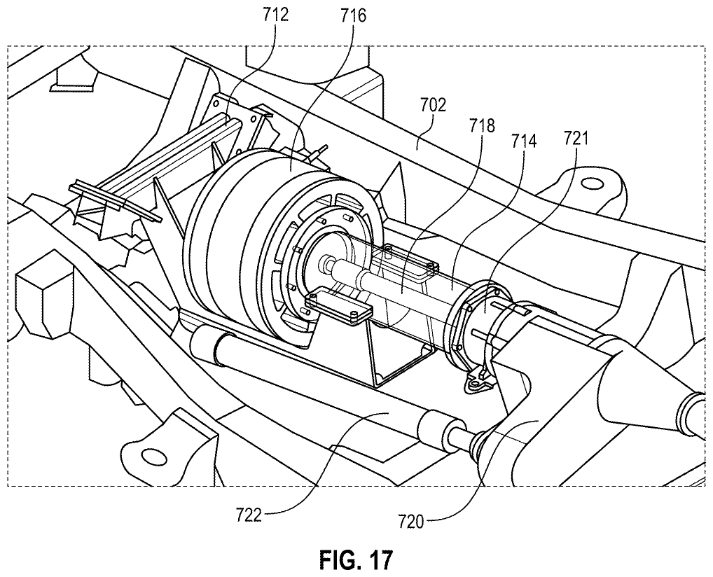

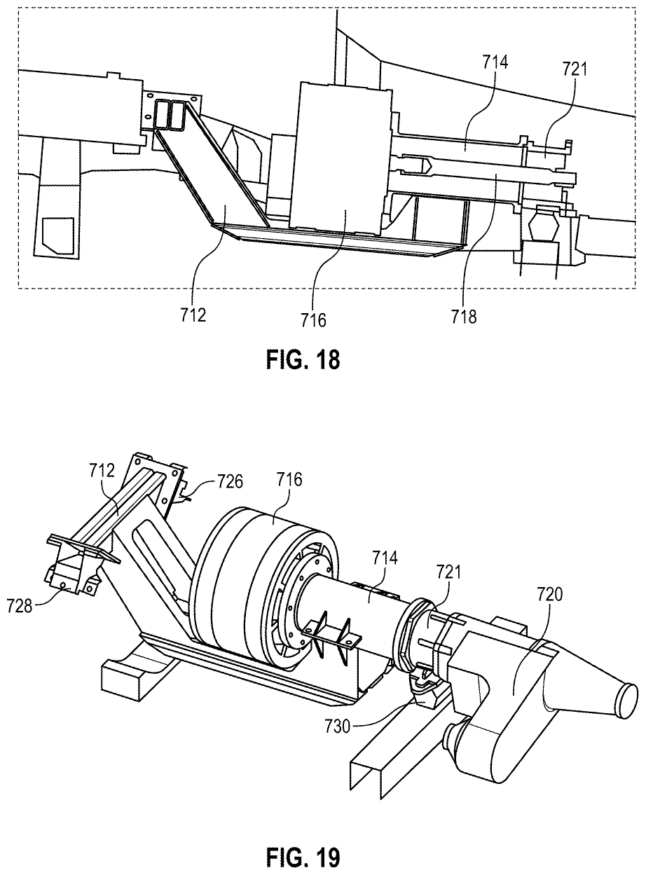

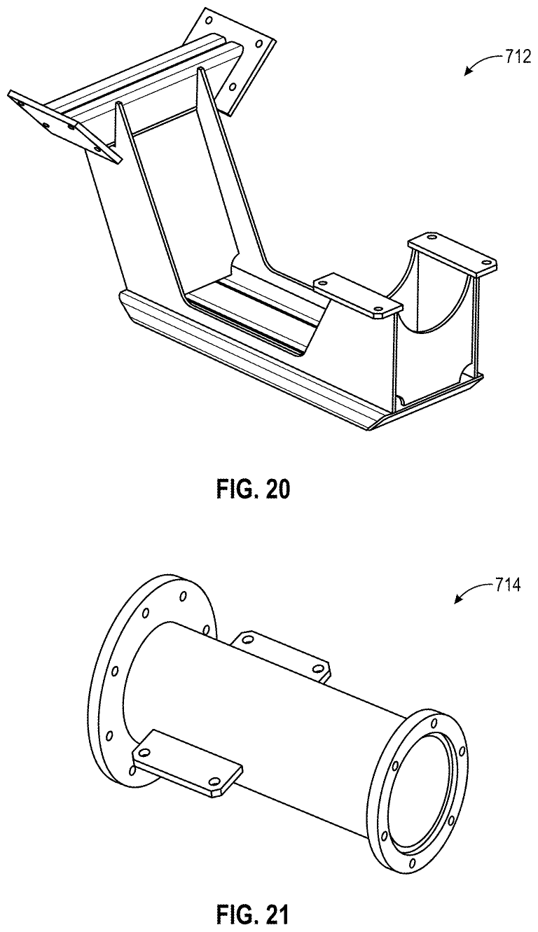

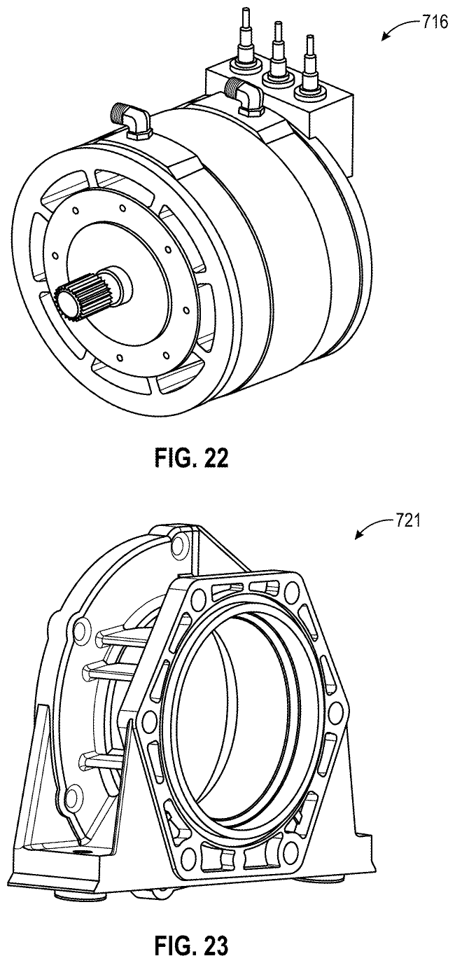

FIGS. 15 through 19 show frame assembly 702 including UBP 704 mounted to frame 709 and powertrain 708. FIGS. 15 and 16 show a perspective view and a top view, respectively of frame assembly 702, in accordance with one exemplary embodiment of the present invention. Powertrain 708 encompasses wireless embedded motor controller 710 for controlling electric motor 716 and braking system through wireless signals from a throttle and a brake pedal on board an interchangeable vehicle body (not shown). In the present embodiment, frame 709 encompasses motor mount weldment 712. FIG. 20 shows the feature of motor mount weldment 712. Motor mount weldment 712 cradles electric motor 716 and bolts onto motor adapter 714. FIG. 21 shows the feature of motor adapter 714. FIG. 22 shows the feature of electric motor 716. As can be seen from FIGS. 21 and 22, motor adapter 714 with the bolt holes on the flange clocked to line up with the electric motor 716. In one example, motor mount weldment 712 cradles with the help of four bolts, with two bolts on each side. Motor adapter 714 encompasses one or more electric motor shafts 718 (FIG. 17) connecting electric motor 716 and transfer case adapter 721. FIG. 23 shows the feature of transfer case adapter 721. FIG. 18 shows a cross-section of motor mount weldment 712, electric motor 716, transfer case 720 (FIG. 25), electric motor shaft 718, motor adapter 714, and transfer case adapter 721. Here, transfer case adapter 721 with the left side having bolt holes that align with the right side of motor adapter 714 in FIG. 21 and bolt holes that line up to the front end of the transfer case 720 in FIG. 25.

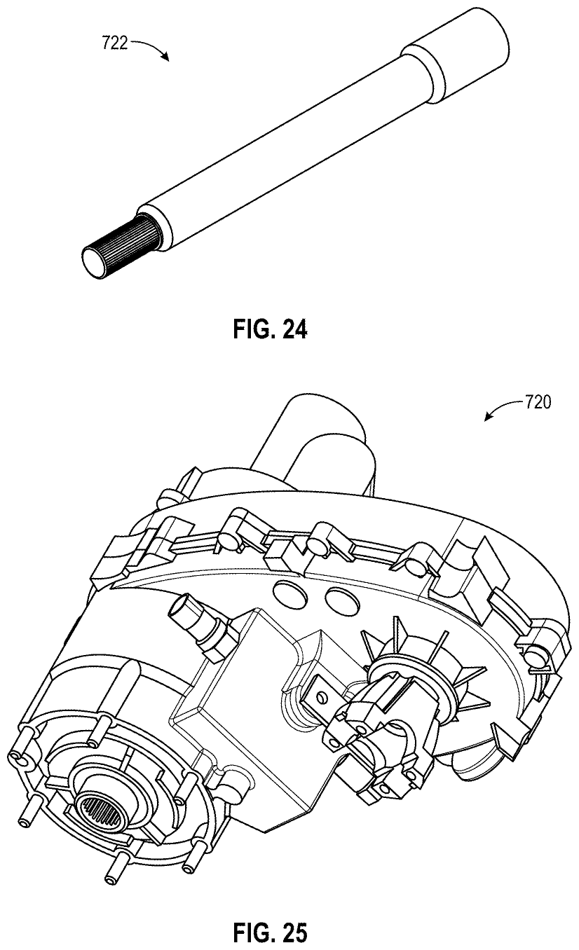

Transfer case adapter 721 connects motor adapter 714 and transfer case 720. In other words, motor adapter 714 is bolted to transfer case 720 through transfer case adapter 721. Two motor shafts are attached to transfer case 720 pointing in opposite directions and can be linked to a differential in the rear and front axles. Transfer case 720 includes drive shaft 722 (half shaft) that links to the front axle differential. FIG. 24 shows the custom electric motor shaft 718 which mechanically links the electric motor 716 to the involute spline of transfer case 720. Custom electric motor shaft 718 has a male splined shaft at one end that fits into transfer case 720 and a female internal spline on the other end that fits into electric motor 716.

In one implementation, motor mount weldment 712 encompasses rubber bushing 724. Rubber bushing 724 is placed in between motor mount assembly and mounting points 726, 728, 730 (FIG. 19) and frame 709 to absorb the vibration and noise that results from the torque of electric motor 716 during operation. FIG. 19 shows the locations of the three mounting points 726, 728, 730 of the motor mount assembly to frame 709. The mounting points 726, 728, 730 form a triangle or “tripod” mount architecture.

In one implementation, powertrain 708 consists of electric motor 716 with a four-wheel drive (4WD), two speed transmission-transfer case and stock front and rear differentials with a rear axle drive shaft to drive the rear wheels and a front axle drive shaft that powers the front wheels. Electric motor 716 is mounted to vehicle 700 with a tripod configuration, given the two mounts behind electric motor 716 and a third mount in front of the electric motor 716 where motor adapter 714 housing mates with transfer case 720. As specified above, mounts are supported with rubber bushings 724 to allow for absorbing torque vibrations of electric motor 716 during operation. The configuration allows for a single motor to provide power to either the rear wheels or all four wheels on electric vehicle 700 through transfer case 720 and front and rear differentials. The configuration also allows for selection of two different gears through a gear selector on the transfer case 720 for a high and low gear. Electric motor 716 and transfer case 720 are linked mechanically through custom drive shaft 722 with an internal spline on the motor side (female end) and an external spline on the transfer case side (male end).

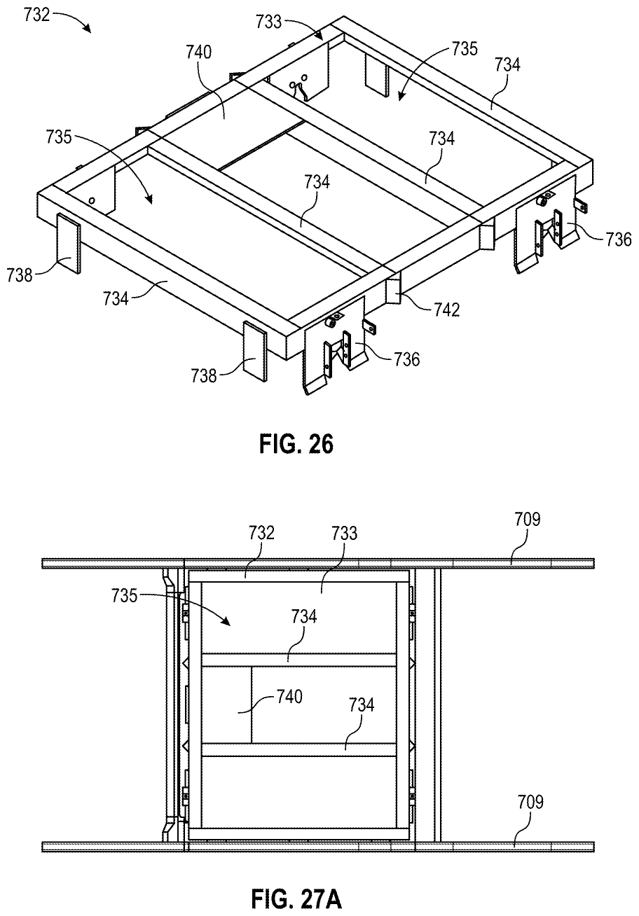

In order to connect battery packs 704 to frame 709, the present invention provides battery collection frame 732. FIG. 26 shows a perspective view of battery collection frame 732, in accordance with one embodiment of the present invention. Battery collection frame 732 may be welded or bolted to an existing frame 709 or form a part of the vehicle platform 709 itself. Battery collection frame 732 includes frames 733 position parallel to each other. Frame 733 encompasses sub-frames 734 positioned at equal distance and perpendicularly to frame 733. Sub-frames 734 connect to frames 733 with the help of reinforcement welds 742. Frames 733 and sub-frames 734 form a rectangular, square or any other configuration with battery pack openings 735 therebetween. Further, frames 733 include adjustable rack frames or latch frames 736 that position at ends of each frame 733. Adjustable rack frames 736 help to adjust a latch assembly to accommodate different battery pack sizes within the same battery collection frame 732. Further, sub-frames 734 include weld or bolt pads 738 that position at ends of sub-frames 736. Bolt pads 738 help to attach the battery collection box to sub-frames 734.

At the center, one of frames 733 encompasses wiring harness/coolant connector mounting pad 740. Coolant connector mounting pad 740 helps to mount the vehicle HV wiring harness to battery packs 704 when inserted into vehicle 700. Reinforcement welds 742 provide added structure to frame 732 in the event of a collision.

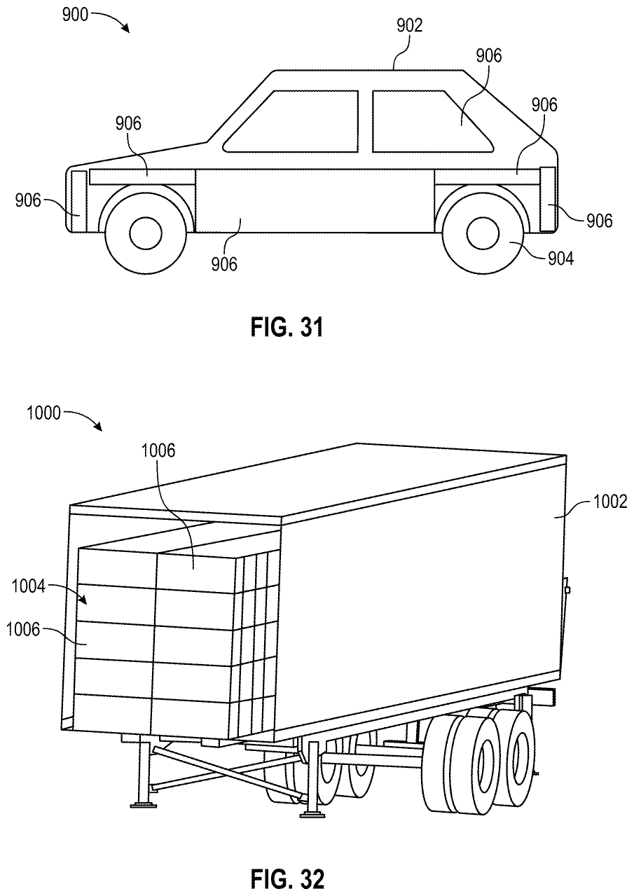

FIGS. 27A, 27B, 27C and 27D show a top view, a side view and a side perspective view, and a rear view of battery collection frame 732 embedded in vehicle frame 709, in accordance with one embodiment of the present invention. In one implementation, the battery collection frame described in FIG. 26 and the vehicle frame in FIG. 16 can be forgone completely and the swappable battery pack itself performs at both a structural member of the vehicle of the vehicle as well as power source to the vehicle as described in FIG. 31, for example.

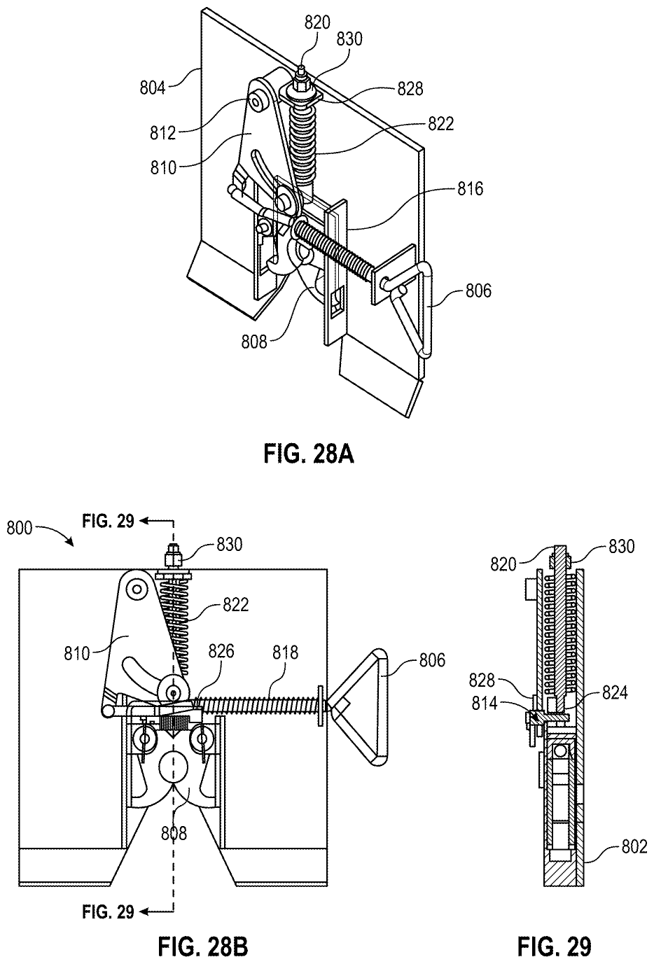

FIGS. 28A and 28B show an isometric view and a front view of a battery collection frame latch assembly 800. Further, FIG. 29 shows a cross-sectional view of battery collection frame latch assembly 800. Here, cross-section 802 is taken along section FIG. 29 from FIG. 28B. Battery collection frame latch assembly 800 includes latch frame 804 and handle bar 806. Handle bar 806 helps to disengage latch frame 804. Battery collection frame latch assembly 800 includes kingpin latch 808, latch cam 810 and cam bushings 812 and 814. Latch frame 804 encompasses lock slide 816. Further, battery collection frame latch assembly 800 includes compression springs 818 for releasing the latch release. In addition, battery collection frame latch assembly 800 includes spring pin 820. Compression springs 822 encompass spring pin 820. Spring pin 822 has Loctite 824 at the end with a flat washer 826. At the other end, spring pin 822 includes another oversized flat washer 828 with a self-locking hex nut 830.

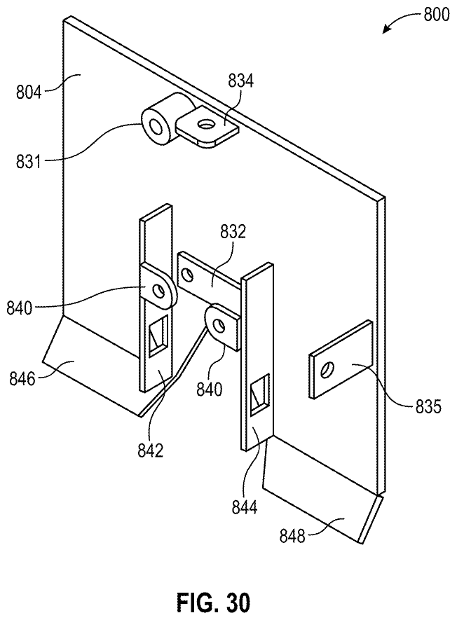

In addition, latch frame 804 includes insertion hole 831 for spring pin 820, as shown in FIG. 30. Latch frame 804 includes casting and bolt hole location 832, 834 for holding compression spring 822 and release handle bar 806. Latch frame 804 includes an insertion point 835 releasing handle bar 806. Latch frame 804 includes bolt hole locations 840 for holding the kingpin latches. Latch frame 804 includes left and right lock slide guides 842 and 844 and left and right latch frame lips 846 and 848. In accordance with the present invention, the latch assembly contains multiple components that form the assembly similar to a standard fifth wheel latch assembly used in on-road heavy duty trucks or any other vehicles. Two or more fifth wheels' latches are placed on battery collection frame latch assembly 800 and adjusted through the racks to align a battery pack with a matching kingpin aligned to the latch slots and the electrical/coolant connections on-board the vehicle platform. The kingpin/fifth wheel latch assembly, forces compliance between the battery pack and the electrical/coolant connections on-board the vehicle platform. The fifth wheel is adjusted through the rack assembly to accommodate different battery pack dimensions and sizes. The latches can be released either manually by a user or automatically through a hydraulic or electrical actuator during swapping.

Although the FIGS. 14 through 30 describe providing a unique vehicle frame for facilitating battery swapping, it is possible to provide battery packs at various locations of the vehicle. FIG. 31 shows an exemplary vehicle 900 in which the battery collection frame and the vehicle frame are forgone completely and the swappable battery pack itself performs as both a structural member of the vehicle of the vehicle as well as power source to the vehicle. In the present embodiment, vehicle 900 includes body 902 and wheels 904. Here, body 902 encompasses individually modular swappable battery packs 906 at various parts of the vehicle platform for performing a dual function of being structural members of the vehicle platform as well as an electrical energy storage source and power source to the vehicle platform.

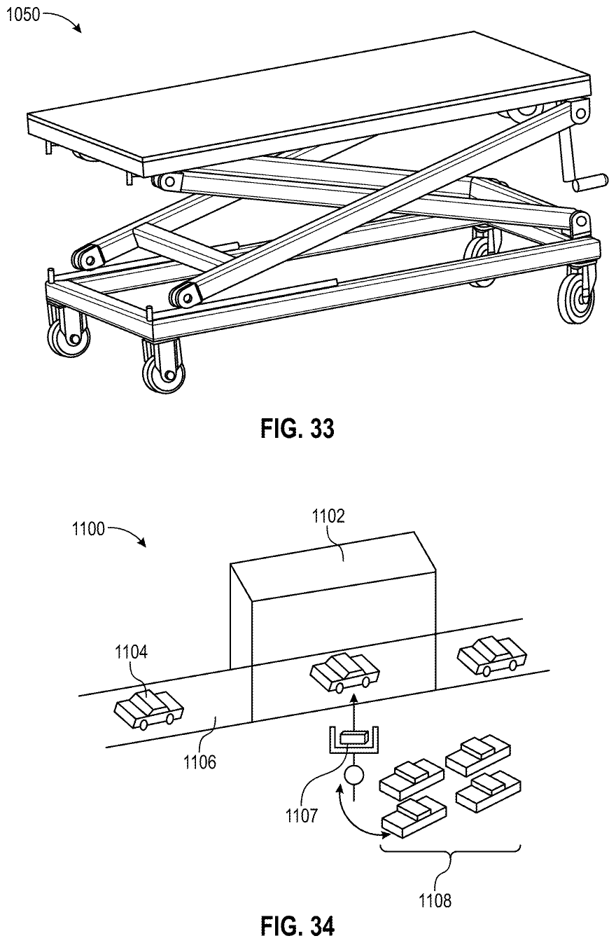

In accordance with the present invention, the unique design of the battery packs and the battery collection frame mounted to the vehicle frame allow to quickly swap the battery packs of the EVs. Here, the battery packs can be swapped from a mobile battery storage unit containing fully charged battery packs or an automated battery swapping terminal containing fully charged battery packs. Now referring to FIG. 32, mobile battery storage unit 1000 storing a plurality of battery packs 1006 is shown. Here, mobile battery storage unit 1000 includes a container 1002 loaded with battery collection boxes 1004 containing fully charged battery packs 1006. Here, a lifting member 1050 as shown in FIG. 33 helps to lift the vehicle and install the battery packs 1006 in a remote location. Mobile battery storage unit 1000 also provides an interface (not shown) of connecting to the onboard battery packs 1006 for charging or discharging the batteries for (Vehicle to Grid) V2G and (Vehicle to Vehicle) V2V or (Battery to Battery) B2B applications.

Alternatively, a battery swapping station 1100 may be utilized, as shown in FIG. 34. Here, battery swapping station 1100 includes stationary or mobile automated battery swapping station 1102. The stationary or mobile automated battery swapping station 1102 includes a vehicle platform 1104, battery and/or vehicle lift (not shown), vehicle alignment guides (not shown), electrical alignment guides (not shown), battery release and conveyor mechanism 1107, battery storage racks and battery rails (not shown) for retrieval of charged batteries and addition of depleted batteries.

In the present exemplary embodiment, vehicles 1104 pulls into stationary or mobile automated battery swapping station 1102, drives onto vehicle platform 1106. Here, vehicle platform 1106 indicates a ramp or platform that lifts the vehicle 1104. Once vehicle 1104 reaches the desired location, tires of vehicle 1104 are adjusted using an alignment mechanism such as rails or guides. Once vehicle 1104 is aligned, the on-board battery pack that is depleted is detached from vehicle 1104 through battery release and conveyor mechanism 1107 and battery pack 1108 is placed in a storage location where the battery pack will be charged, next a battery pack 1108 is pulled through release and conveyor mechanism 1107 from a pile of charged batteries 1108 and attached to vehicle 1104 from underneath, as shown in FIG. 33. When vehicle 1104 is lowered, assuming it has been raised by vehicle platform 1106 previously and the swap is completed. For a manual battery swap, when vehicle 1104 arrives at stationary or mobile automated battery swapping station 1102 for a swap, vehicle 1104 climbs unto vehicle platform 1106, the depleted battery pack 1108 is removed from vehicle 1104 by placing battery pack 1108 lift underneath vehicle 1104, raising the height of the lift until it meets the guides on vehicle 1104. Further, a spring loaded latch is released so that the weight of battery pack 1108 is supported by the lift. Subsequently, the lift is lowered and depleted battery pack 1108 is inserted inside an empty slot on a battery storage unit (mobile battery storage unit 1000, for example). Following the removal, a charged battery pack 1108 is rolled out of the mobile battery storage unit 1000 and placed on the battery pack lift 1050, the battery pack 1108 is then slid underneath the vehicle 1104 with the battery pack lift 1050 and guided into the vehicle 1104 again through the guides on the vehicle 1104. Further, battery pack 1108 is raised upwards until battery pack 1108 is latched securely onto vehicle 1104 and the swap is completed.

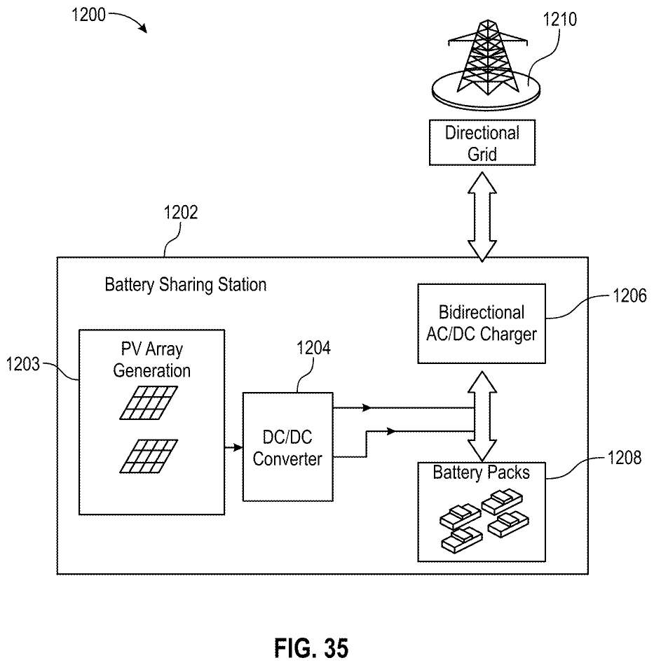

In one implementation, battery swapping station 1100 is equipped with local energy generation and a bidirectional charger that is tied to an electricity grid. FIG. 35 shows an electrical architecture 1200 of a battery swapping station or battery sharing station (BSS) 1202 equipped with local energy generation and a bidirectional charger 1206 that is tied to an electricity grid 1210. Here, BSS 1202 includes photo-voltaic (PV) modules or solar panels 1203 capable of generating direct current (DC) electricity. A person skilled in the art understands any renewable energy generation can be used in place of PV modules 1203 at BSS 1202. BSS 1202 includes DC/DC converter 1204. Here, DC/DC converter 1204 powers the electrical components within battery packs 1208 for recharging them. Bidirectional charger 1206 consists of a bidirectional DC/DC converter, isolating transformer between the DC converter and AC converter, a full-bridge AC/DC converter which consists of power semiconductor switching devices such as wide band gap switching devices made of SiC or GaN material, an EMI filter composed of an inductor and capacitor.

Here, BSS 1202 is dependent on distribution grid 1210 and represents new high-power consumption loads for the distribution system operators. In accordance with the present invention, the electrical components of BSS 1202 are mainly composed of a distribution transformer, AC/DC chargers, battery packs, and a battery energy control module (BECM). The distribution grid 1210 provides the AC power at the distribution voltage level, and because of the high power demand of BSS 1202, this voltage level will be between 33 kV and 11 kV. Charging power levels for EV battery packs range from Level 1 charging at 120 V/15 A single-phase; Level 2 Charging at 240 V (up to 80 A, 19.2 kW); and Level 3 Charging at 50 kW and up. Depending on the size of BSS 1202 and the voltage level available at distribution grid 1210, different charging modes can be implemented. The current state-of-the-art implementation of BSS 1202 possesses several technical and economic challenges. Such challenges are the nonstandard battery interface across EV manufacturers and consumer acceptance of not owning their battery or their original battery being tampered with and replaced with a lower performance battery during a swap. Another critical challenge is the heavy dependency of the BSS on the distribution grid, and the high power demand of the BSS, which could have a negative impact on the grid during peak loading periods. In accordance with the present invention, the proposed electrical architecture 1200 of BSS 1202 achieves a common standardized modular battery interface across EV manufacturers. In addition, a renewable energy generation such as solar-power 1203 and bidirectional AC/DC charging interface 1206 are introduced, which allow BSS 1202 to become a service utility that supports distribution grid 1210 in terms of distributed generation and storage. Bidirectional AC/DC converter 1206 allows battery packs 1208 in BSS 1202 to provide V2G services to the smart grid.

FIG. 36 shows a network diagram of a battery swapping network (BSN) 1300, in accordance with further embodiment of the architecture described in FIG. 35. Battery swapping network 1300 consists of a battery sharing network (BSN) management system 1302, one or more battery swapping stations (BSS) 1304, participating electric and autonomous vehicles 1306 and distribution grid/smart grid 1308. In the present embodiment, BSS 1304 is an integral part of battery swapping network 1300 and consists of mechanical, structural and electrical components, as explained above using at least FIGS. 32 through 35. Here, battery swapping network 1300 is linked together through internet of things (IoT) and telecommunication interfaces. The battery swapping network 1300 communicates through internet of things (IoT) and telecommunication interfaces to optimize the cost of charging, reduce the waiting time for battery swaps by forecasting battery swaps and share the modular battery packs amongst each other through participating EVs and EV customers. EV owners can participate in battery swapping network (BSN) 1300 and transport battery packs from BSS 1304 where they are located to BSS 1304 where they are needed for incentives such as free battery swaps or payment. The battery packs are transported from one BSS 1304 to another BSS 1304 through the embedded UBP slots on optimized routes convenient for EV owners. This reduces, or completely eliminates, the need for dedicated vehicles for transportation of EV battery packs 1308 from one BSS 1304 to another BSS 1304. BSN 1300 provides a means by which electric vehicles 1306 can share the valuable resource, the battery, amongst each other, through the optimization of different duty cycles of vehicles within the network. This reduces the overall cost of electric vehicles 1306 as the utilization of the resources can be maximized. Another advantage is that the batteries can be charged off-board electric vehicles 1306 at much slower rates, when electricity is cheaper, and swapped into a vehicle quickly, reducing the need for Direct-current fast charger (DCFC) and avoiding its degradation effects on the battery. BSN 1300 ensures the charging load is much more predictable, as the battery packs are scheduled ahead of time, and it can take advantage of the “feast or famine” nature of renewable energy generation with an aggregation of battery swapping stations providing temporary energy storage buffers to store energy when there is surplus and returning some of that energy back into the grid when demand exceeds generation. Battery swapping stations 1304 within BSN 1300 are connected together through internet of things (IoT) and communicate to optimize the charging costs of the battery packs, maximize utilization of the battery packs, and reduce wait times for battery swapping or vehicle platform swapping through scheduling and forecasting of swap demand and optimal routing of mobile battery swapping stations.

FIG. 37 shows an architectural diagram of a cloud connected charge management system (CMS) 1400, in accordance with a further embodiment of the battery swapping network described using FIG. 36. CMS 1400 includes battery sharing network backend services 1402. A user 1404 of an electric vehicle or fleet customer accesses battery sharing network backend services 1402 using user device 1406. Alternatively, Battery dispatchers or EV customers 1408 use their user devices 1406 to access battery sharing network backend services 1402. Here, user 1404 or battery dispatchers 1408 accesses CMS 1400 using an application such as a web/mobile application or in-vehicle mobile application interface on user device 1406. User device 1406 includes, but not limited to, mobile phone, tablet, vehicle dashboard containing wireless communication modules, etc. User 1404 or battery dispatcher 1408 may access CMS 1400 for scheduling of battery/vehicle platform swaps. Here, CMS 1400 implements an http client-server communication medium 1408 between it and user device 1406.

In one implementation, CMS 1400 includes a database 1410 all the data, including but not limited to, user data, battery dispatchers' data, health of the battery packs, status of vehicle platform swaps, charging status, etc. CMS 1400 implements a custom APIs 1412 to access battery sharing network backend services 1402. Further, user devices 1406 are capable of accessing the data corresponding to battery sharing station (BSS) 1416 and smart grid 1418, as explained above using FIGS. 34 and 35. Whenever user device 1406 accesses, the logging-in data is stored in analytics module 1414. Analytics module 1414 helps to generate reports corresponding to data stored, accessed by users, mobile swapping station dispatch and assignment, etc. From the real-time inputs and analytical models deduced from analytics module 1414, managers of CMS 1400 can make decisions on battery/vehicle platform swap scheduling and routing, battery charging/discharging, mobile battery swapping station assignment and routing and many more optimization and control functions.

Battery sharing network backend services 1402 integrates software modules (i.e., a set of program instructions) such as battery supply module 1420, charging and discharging module 1422, battery demand module 1424, billing module and billing services module 1426, smart grid services module 1428 and location/geofencing/mapping service module 1430, etc. Battery supply module 1420 manages the data corresponding to the number of available battery packs in the network. Charging and discharging module 1422 manages the data corresponding to charge left in the battery packs or life or degradation status of the battery packs. Billing module and billing services module 1426 manages the data corresponding to payments from EV swapping and charging customers and also handling payment of electricity usage from the distribution smart grid. Smart grid services module 1428 monitors the grid electricity costs, real-time grid load and demand, forecasted load, price and demand. Location/geofencing/mapping service module 1430 is responsible for understanding the geographical location distribution of the assets and components in the battery sharing network, segmenting different portions of the system geographically, and routing EV/AV customers, mobile swapping station dispatch and assignment.

For each of the battery packs in the network, CMS 1400 coordinates the bidirectional flow of power between the BSS and the smart grid which is designed for distributed generation and bidirectional power flow. CMS 1400 also coordinates the optimized routing of boost battery packs in BSN (say BSN 1300) through the EVs that participate in the network. CMS 1400 integrates the data from multiple sources across BSN 1300 using an artificial intelligence (AI)/machine learning (ML) framework. In addition, BSN management system 1302 controls the scheduling of battery swaps as well as forecasting of future swaps and grid loading. Here, BSN management system 1302 becomes a grid utility, providing services to the grid, such as peak shaving and load balancing, and serves as a reserve for the grid during contingency situations.

The benefits and advantages that may be provided by the present invention have been described above regarding specific embodiments. These benefits and advantages, and any elements or limitations that may cause them to occur or to become more pronounced are not to be construed as critical, required, or essential features of any of any or all of the claims. As used herein, the singular forms “a”, “an”, and “the” are intended to include the plural forms as well, unless the context clearly indicates otherwise. It is further understood that the terms “comprises” and/or “comprising” or “includes” and/or including”, or any other variation thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment. These terms when used in this specification, specify the presence of stated features, regions, integers, steps, operations, elements, and/or components, but do not preclude the presence or addition of one or more features, regions, integers, steps, operations, elements, components, and/or groups thereof.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in figures are provided for illustrative purposes only and should not be construed in a limited sense. A person skilled in the art will appreciate alternate components that might be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants within the scope of the invention.

What is claimed is:

1. A battery pack, comprising:
a cooling fan;
a compressor;
a coolant pump;
a radiator and a condenser;
a cooling plate;
a coolant plate heat exchanger adhering to said cooling plate;
a high voltage Direct Current (DC) connection;
a DC/DC converter for powering electrical components within the battery pack; and
a Battery Management System (BMS) embedded within said battery pack,
wherein said BMS comprises a wireless communication module capable of monitoring, sensing and control of the battery pack remotely, and
wherein said BMS controls the operation of each of said cooling fan, said compressor, said coolant pump, said radiator and said condenser, said cooling plate, said coolant plate heat exchanger, said high voltage DC connection, and said DC/DC converter without a need for external cooling inlet and outlet channels.

2. The battery pack of claim 1, further comprises a battery latch assembly, and wherein said battery latch assembly receives said battery pack.

3. The battery pack of claim 2, wherein said battery latch assembly comprising said battery pack is attached to a battery collection frame.

4. The battery pack of claim 3, wherein said battery collection frame is connected to a vehicle platform of a vehicle.

5. The battery pack of claim 3, wherein said battery collection frame is capable of attaching and detaching varied configuration of said battery back from said vehicle platform.

6. The battery pack of claim 3, wherein said battery collection frame comprises a kingpin, wherein said vehicle platform comprises a kingpin receiver, and wherein said kingpin aligns with said kingpin receiver and secures said battery pack to said vehicle platform.

7. The battery pack of claim 5, wherein said battery collection frame comprises an adjustable rack assembly, and wherein said adjustable rack assembly configures to receive said battery pack in said battery collection frame and attach to said vehicle platform.

8. The battery pack of claim 5, wherein said battery pack powers a motor capable of producing rotational power to multiple axles and wheels of said vehicle independent of each other.

9. The battery pack of claim 8, wherein said motor and said battery pack replaces an internal combustion engine in said vehicle.

10. The battery pack of claim 1, wherein said battery pack communicatively connects to a battery sharing network (BSN) comprising one or more battery swapping stations and electric vehicles or autonomous electric vehicles participating in a network.

11. The battery pack of claim 10, wherein said one or more battery swapping stations allow swapping of the battery pack either automatically or manually either on-board the vehicle at a swapping station or off-board the vehicle with a mobile battery storage unit at a swapping location.

12. The battery pack of claim 10, wherein said one or more battery swapping stations allow charging of the battery pack either on-board the vehicle or off-board the vehicle in a battery storage unit at a swapping location.

13. The battery pack of claim 10, wherein said BSN comprises a battery sharing network management system, wherein said battery sharing network management system monitors, controls, routes and dispatches said battery pack, said electric vehicles or autonomous vehicles within said network.

14. The battery pack of claim 13, wherein said battery sharing network management system configures to optimize the charge and discharge of the battery pack in the network based on one of:
time of use forecast data for the electricity grid,
day ahead and real time schedule data of electric or autonomous vehicles within the network, and
telemetry data including location, speed, and state of charge from vehicles within the network.

15. The battery pack of claim 1, wherein said battery pack is interchangeable with a main battery pack of an electric vehicle or adds as a range extender within said electric vehicle.

16. The battery pack of claim 10, wherein said one or more battery swapping stations configure to move from one location to another based on a real time or forecasted swapping or charging demand.

17. The battery pack of claim 13, further comprises a bidirectional charger, wherein said bidirectional charger connects to said battery pack, said one or more battery swapping stations and an electricity grid, and wherein said bidirectional charger manages charge distribution and storage of said battery pack, said one or more battery swapping stations and said electricity grid.

18. The battery pack of claim 1, wherein said BMS monitors and determines a state of said battery pack.

19. A method of providing a battery pack, the method comprising the steps of:
providing a cooling fan, a compressor, a coolant pump, a radiator and a condenser, a cooling plate, a coolant plate heat exchanger adhering to said cooling plate, a high voltage Direct Current (DC) connection, a DC/DC converter powering electrical components within said battery pack;
providing a Battery Management System (BMS) embedded within said battery pack;
providing a wireless communication module within said BMS for monitoring, sensing and control of said battery pack remotely; and
controlling the operation of each of said cooling fan, said compressor, said coolant pump, said radiator and said condenser, said cooling plate, said coolant plate heat exchanger, said high voltage DC connection, and said DC/DC converter using said BMS without a need for external cooling inlet and outlet channels.

20. The method of claim 19, further comprising:
communicatively connecting to a battery sharing network (BSN) comprising one or more battery swapping stations and electric vehicles or autonomous electric vehicles participating in a network;
swapping of the battery pack either automatically or manually either on-board the vehicle or off-board the vehicle in a battery storage unit at a swapping location;
monitoring, controlling, routing and dispatching said battery packs, said electric vehicles or autonomous vehicles within said network; and
accessing information corresponding to monitoring, controlling, routing and dispatching said battery pack, said electric vehicles or autonomous vehicles within said network.
